(19) United States
(12) Patent Application Publication
(10) Pub. No.: US 2026/0112041 A1
(43) Pub. Date: Apr. 23, 2026

(54) OBJECT TRACKING USING A HEAD-MOUNTED DISPLAY

(71) Applicant: Meta Platforms Technologies, LLC, Menlo Park, CA (US)

(72) Inventors: Chi Hang Boyce Tsang, Mill Creek, WA (US); Howard Sun, Seattle, WA (US)

(21) Appl. No.: 18/924,879

(22) Filed: Oct. 23, 2024

(51) Int. Cl. G06T 7/20; G06T 7/13; G06T 7/70; G06V 10/44; G06V 10/54; G06V 20/70

(52) U.S. Cl. CPC G06T 7/20; G06T 7/13; G06T 7/70; G06V 10/44; G06V 10/54; G06V 20/70

(57) ABSTRACT

As disclosed herein, a computer-implemented method for object tracking is provided. The computer-implemented method may include capturing, by a first client device, an image of a second client device. The computer-implemented method may include determining, by a sensor associated with the second client device, a position of the second client device within a physical space surrounding the first and the second client devices. The computer-implemented method may include labeling the image of the second client device with the position of the second client device. The computer-implemented method may include adding the image to a training dataset. The computer-implemented method may include training, based on the training dataset, a model configured to determine an object position within a field of view of the first client device. A system and a non-transitory computer-readable storage medium are also disclosed.

### BACKGROUND

### Field

The present disclosure generally relates to object tracking. More particularly, the present disclosure relates to tracking of a handheld controller within a field of view of a head-mounted display (HMD).

### Related Art

The rapid advancement of mixed reality (MR) technologies has significantly increased the need for more sophisticated object tracking systems to enable users to seamlessly manipulate digital objects and navigate MR environments. Traditional methods for object tracking may include marker-based tracking systems, which may utilize predefined markers to precisely determine the position or orientation of an object (e.g., a handheld controller) in a physical space. Predefined markers may include external structures (e.g., sensors, indicators) affixed to the object. Cameras, which may be positioned around the object, may capture images of the physical space, including the predefined markers affixed to the object, as the object moves through the physical space. The images may be used to determine the position or orientation of the object in the physical space and to render a digital representation of the object in the MR environment.

### SUMMARY

The subject disclosure provides for systems and methods for object tracking for mixed reality (MR) environments. As disclosed herein, one or more sensors (e.g., one or more cameras) may be integrated into an object (e.g., a handheld controller). The one or more sensors may be used to capture images of a physical space surrounding the object. The images may be used to determine the position of the object in the physical space. In some embodiments, the position of the object in the physical space may be used to train an artificial intelligence (AI) model to determine the position of a digital representation of the object in a field of view of a head-mounted display (HMD) communicatively coupled with the object.

According to certain aspects of the present disclosure, a computer-implemented method is provided. The computer-implemented method may include capturing, by a first client device, an image of a second client device. The computer-implemented method may include determining, by a sensor associated with the second client device, a position of the second client device within a physical space surrounding the first and the second client devices. The computer-implemented method may include labeling the image of the second client device with the position of the second client device. The computer-implemented method may include adding the image to a training dataset. The computer-implemented method may include training, based on the training dataset, a model configured to determine an object position within a field of view of the first client device.

According to another aspect of the present disclosure, a system is provided. The system may include one or more processors. The system may include a memory storing instructions that, when executed by the one or more processors, cause the system to perform operations. The operations may include capturing, by a first client device, an image of a second client device. The operations may include determining, by a sensor associated with the second client device, a position of the second client device within a physical space surrounding the first and the second client devices. The operations may include labeling the image of the second client device with the position of the second client device. The operations may include adding the image to a training dataset. The operations may include training, based on the training dataset, a model configured to determine an object position within a field of view of the first client device.

According to yet other aspects of the present disclosure, a non-transitory computer-readable storage medium storing instructions encoded thereon that, when executed by a processor, cause the processor to perform operations, is provided. The operations may include capturing, by a first client device, an image of a second client device. The first client device may include a head-mounted display (HMD), and the second client device may include at least one handheld controller communicatively coupled with the HMD. The operations may include determining, by a sensor associated with the second client device, a position of the second client device within a physical space surrounding the first and the second client devices. The sensor associated with the second client device may include an integrated sensor of the second client device. The operations may include labeling the image of the second client device with the position of the second client device. The operations may include adding the image to a training dataset including a plurality of images of the second client device labeled with a plurality of positions of the second client device. The operations may include training, based on the training dataset, a model configured to determine an object position within a field of view of the first client device. The operations may include rendering, based on the model, a digital representation of the second client device in a display of the first client device. The digital representation of the second client device may be visually consistent with the image of the second client device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for object tracking using integrated components of the object, according to some embodiments;

FIG. 2 is a block diagram illustrating details of an example client device and an example server from the environment of FIG. 1, according to some embodiments;

FIG. 3 illustrates an example configuration for object tracking using integrated cameras of an object, according to some embodiments;

FIG. 4 illustrates an example configuration for object tracking using non-integrated cameras associated with an object, according to some embodiments;

FIG. 5 is a flowchart illustrating operations in a method for object tracking using integrated components of the object, according to some embodiments; and

FIG. 6 is a block diagram illustrating an exemplary computer system with which client devices, and the methods in FIG. 5, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The rapid advancement of mixed reality (MR) technologies has significantly increased the need for more sophisticated object tracking systems to enable users to seamlessly manipulate digital objects and navigate MR environments. Traditional methods for object tracking may include marker-based tracking systems, which may utilize predefined markers to precisely determine the position or orientation of an object (e.g., a handheld controller) in a physical space. Predefined markers may include external structures (e.g., sensors, indicators) affixed to the object. Cameras, which may be positioned around the object, may capture images of the physical space, including the predefined markers affixed to the object, as the object moves through the physical space. The images may be used to determine the position or orientation of the object in the physical space and to render a digital representation of the object in the MR environment.

However, existing marker-based systems may suffer from issues that impact tracking accuracy, such as occlusion, environmental constraints, and dependency on external structures. Therefore, there is a need for a more robust object tracking solution that leverages the capabilities of integrated components of an object.

As disclosed herein, novel systems and methods represent a significant advancement in the field of object tracking technology by utilizing integrated components (e.g., sensors, indicators) of an object to determine a position or an orientation of the object in a physical space (or a portion thereof). The position or orientation may be used to label an image of the object captured by a client device, and the labeled image may be used in a dataset for training an artificial intelligence (AI) model (e.g., a machine learning (ML) model) configured to determine an object position or orientation within a field of view of the client device.

According to some embodiments, a mixed reality (MR) application running on a client device (e.g., a mobile phone or a head-mounted display (HMD)) may capture one or more images of an object (e.g., a handheld controller) as the object moves through a physical space surrounding the client device and the object. In some aspects of the embodiments, the client device may capture the one or more images of the object using one or more external or world-facing cameras of the client device. The object may include one or more integrated cameras. The integrated cameras may capture one or more images of the physical space (or a portion thereof). The one or more images of the physical space may be used to determine one or more positions or orientations of the object within the physical space. The one or more positions or orientations of the object may be used to label the one or more images of the object. The one or more labeled images may be added to a dataset for training an artificial intelligence (AI) model (e.g., a machine learning (ML) model) configured to determine a position or an orientation of the object within a field of view of the client device. The position or orientation of the object within the field of view of the client device may be used to render a digital representation of the object within a field of view of the client device.

According to some embodiments, a mixed reality (MR) application running on a client device (e.g., a mobile phone or a head-mounted display (HMD)) may capture one or more images of an object (e.g., a handheld controller) as the object moves through a physical space surrounding the client device and the object. In some aspects of the embodiments, the client device may capture the one or more images of the object using one or more external or world-facing cameras of the client device. The object may include one or more integrated infrared (IR) light-emitting diodes (LEDs). One or more external cameras may be positioned within the physical space and around the object. The one or more external cameras may capture one or more images of the physical space (or a portion thereof), which includes the one or more IR LEDs of the object. The one or more images of the physical space may be used to determine one or more positions or orientations of the object within the physical space. The one or more positions or orientations of the object may be used to label the one or more images of the object. The one or more labeled images may be added to a dataset for training an artificial intelligence (AI) model (e.g., a machine learning (ML) model) configured to determine a position or an orientation of the object within a field of view of the client device. The position or orientation of the object within the field of view of the client device may be used to render a digital representation of the object within a field of view of the client device.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

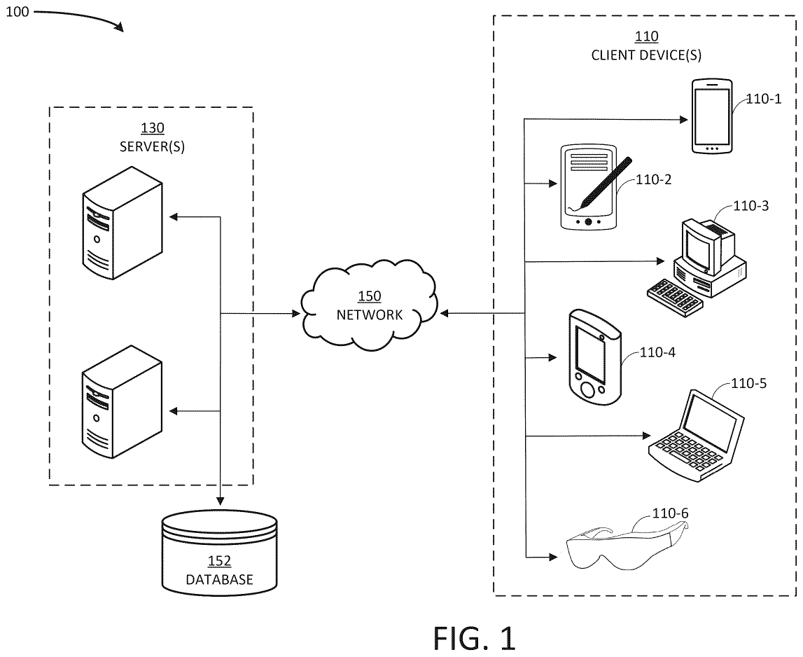

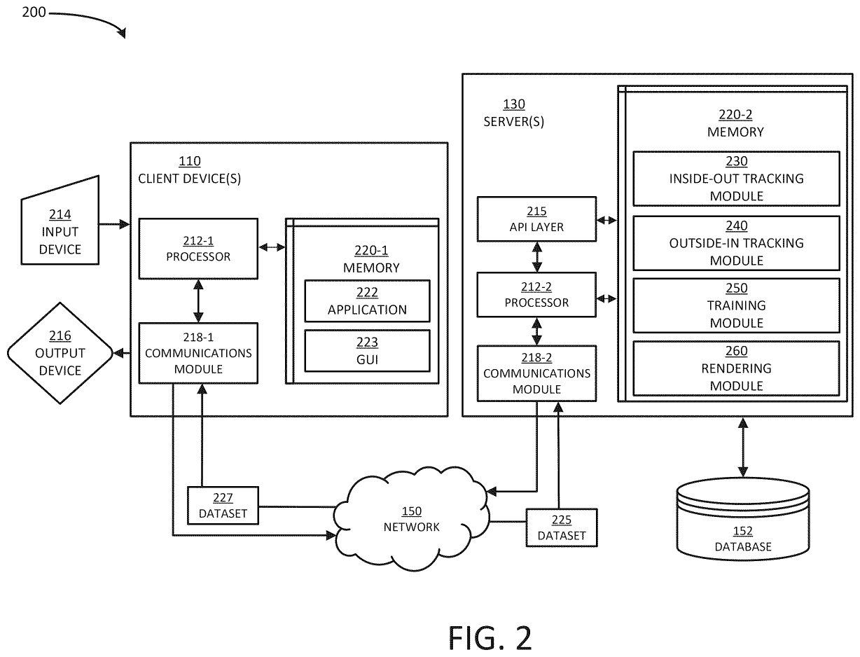

FIG. 1 illustrates an example environment 100 suitable for object tracking for a mixed reality (MR) environment, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing an inside-out tracking module, an outside-in tracking module, a training module, or a rendering module (e.g., inside-out tracking module 230, outside-in tracking module 240, training module 250, or rendering module 260, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and database 152 including multiple training archives for the inside-out tracking module, the outside-in tracking module, the training module, or the rendering module. Moreover, in some embodiments, multiple users of client device(s) 110 may access the same inside-out tracking module, outside-in tracking module, training module, or rendering module. In some embodiments, a single user with a single client device (e.g., one of client device(s) 110) may provide images and data (e.g., text) to train one or more artificial intelligence (AI) models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for an inside-out tracking module, an outside-in tracking module, a training module, or a rendering module. Any of the inside-out tracking module, the outside-in tracking module, the training module, or the rendering module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., an extended reality (XR) headset, smart glass, or head-mounted display (HMD), including a virtual reality (VR), augmented reality (AR), or mixed reality (MR) headset, smart glass, or HMD), such that at least one participant may be running an extended reality application-including a virtual reality application, an augmented reality application, or mixed reality application-installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating details of example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an XR/AR/VR/MR headset (or head-mounted display (HMD)). For example, in some embodiments, input device 214 may include an eye-tracking device to detect the position of a pupil of a user in an XR/AR/VR/MR headset (or HMD). Likewise, output device 216 may include a display and a speaker with which the customer may retrieve results from client device(s) 110. Client device(s) 110 may also include processor 212-1, configured to execute instructions stored in memory 220-1, and to cause client device(s) 110 to perform at least some of the steps in methods consistent with the present disclosure. Memory 220-1 may further include application 222 and graphical user interface (GUI) 223, configured to run in client device(s) 110 and couple with input device 214 and output device 216. Application 222 may be downloaded by the user from server(s) 130 or may be hosted by server(s) 130. In some embodiments, client device(s) 110 may be an XR/AR/VR/MR headset (or HMD) and application 222 may be an extended reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include inside-out tracking module 230, outside-in tracking module 240, training module 250, or rendering module 260. Inside-out tracking module 230, outside-in tracking module 240, training module 250, or rendering module 260 may share or provide features or resources to GUI 223, including any tools associated with an extended reality application (e.g., application 222). A user may access inside-out tracking module 230, outside-in tracking module 240, training module 250, or rendering module 260 through application 222, installed in a memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Inside-out tracking module 230 may be configured to leverage one or more integrated sensors (e.g., camera, depth sensor, infrared (IR) sensor, inertial measurement unit (IMU), Global Positioning System (GPS) receiver) of an object (e.g., a handheld controller) to track a position or an orientation of an object in a physical space surrounding the object. An integrated sensor may be a physical component of the object. An integrated sensor may be coupled to, affixed to, adhered to, embedded in, or otherwise physically connected to the object. Inside-out tracking module 230 may be configured to leverage artificial intelligence (AI) algorithms to map the physical space. Mapping the physical space may include identifying a distinct feature of the physical space (e.g., an edge, a corner, a texture, a surface, an object, an obstacle). Inside-out tracking module 230 may use one or more features of the physical space as reference points to determine a position or an orientation of the object within the physical space as the object moves within the physical space. By continuously detecting or analyzing the movement of the object relative to the reference points, inside-out tracking module 230 may determine a position or an orientation of the object in real time.

In some embodiments, the object may include a camera to capture an image of the physical space. In some aspects of the embodiments, the image may include a true-color (also known as natural-color) image, which may refer to an image that accurately depicts colors as the colors would be perceived by the human eye in natural daylight (e.g., RGB images). In some aspects of the embodiments, the image may include a false-color (also known as pseudo-color) image, which may refer to an image that does not depict colors as the colors would be perceived by the human eye in natural daylight (e.g., infrared (IR) images). False-color images may be created using solely the visual spectrum, or false-color images may be created at least partially from electromagnetic radiation (EM) data outside the visual spectrum (e.g., infrared, ultraviolet, or X-ray). In some embodiments, the object may include an IMU, which may include an accelerometer or a gyroscope. Inside-out tracking module 230 may utilize IMU data and image data to determine a position or an orientation of the object in the physical space or to improve an accuracy of a position or an orientation of the object in the physical space.

Outside-in tracking module 240 may be configured to leverage one or more non-integrated sensors (e.g., camera, depth sensor, infrared (IR) sensor, inertial measurement unit (IMU), Global Positioning System (GPS) receiver) associated with an object (e.g., a handheld controller) to track a position or an orientation of the object in a physical space surrounding the object. A non-integrated sensor may be an external device associated with the object (e.g., a motion-capture camera situated in the physical space). A non-integrated sensor may be uncoupled from, unaffixed to, unadhered to, unembedded in, or otherwise physically disconnected from the object. Outside-in tracking module 240 may be configured to leverage artificial intelligence (AI) algorithms to map the physical space. Mapping the physical space may include identifying a distinct feature of the physical space (e.g., an edge, a corner, a texture, a surface, an object, an obstacle). Outside-in tracking module 240 may use one or more features of the physical space as reference points to determine a position or an orientation of the object within the physical space as the object moves within the physical space. By continuously detecting or analyzing the movement of the object relative to the reference points, outside-in tracking module 240 may determine a position or an orientation of the object in real time.

In some embodiments, the object may include an integrated component (e.g., an infrared (IR) light-emitting diode (LED)) that may be detected by a non-integrated sensor to track a position or an orientation of the object in the physical space. An integrated component may be a physical component of the object. An integrated component may be coupled to, affixed to, adhered to, embedded in, or otherwise physically connected to the object. The non-integrated sensor may include a camera to capture an image of the object or the physical space surrounding the object. In some aspects of the embodiments, the image may include a true-color (also known as natural-color) image, which may refer to an image that accurately depicts colors as the colors would be perceived by the human eye in natural daylight (e.g., RGB images). In some aspects of the embodiments, the image may include a false-color (also known as pseudo-color) image, which may refer to an image that does not depict colors as the colors would be perceived by the human eye in natural daylight (e.g., infrared (IR) images). False-color images may be created using solely the visual spectrum, or false-color images may be created at least partially from electromagnetic radiation (EM) data outside the visual spectrum (e.g., infrared, ultraviolet, or X-ray). In some embodiments, the object may include an IMU, which may include an accelerometer or a gyroscope. Outside-in tracking module 240 may utilize IMU data and image data to determine a position or an orientation of the object in the physical space or to improve an accuracy of a position or an orientation of the object in the physical space.

Training module 250 may be configured to train an artificial intelligence (AI) model (e.g., a machine learning (ML) model) to determine a position or an orientation of an object within a field of view of a client device (e.g., a mobile phone, a head-mounted display (HMD)). A dataset for training, validating, or testing the AI model may include a plurality of images of the object. The plurality of images may be captured by the client device as the client device or the object moves within a physical space surrounding the client device and the object. The plurality of images of the object may be captured under various conditions, including different angles, lighting, backgrounds, or distances. Each image of the plurality of images may be labeled with position or orientation data. The position or orientation data may include, respectively, a position or an orientation of the object within the physical space at the time the image was captured.

In some embodiments, training module 250 may determine whether the dataset includes at least a threshold number of variations (e.g., occlusions, backgrounds, lighting conditions) to improve the robustness of the AI model. In some embodiments, one or more AI techniques may be implemented to ensure diversity of the dataset used to train, validate, or test the AI model. For example, one or more AI techniques may be implemented to obtain data from various sources, to detect or mitigate biases in the dataset, to augment the dataset, or to audit the dataset. In some embodiments, data that does not pass one or more sensor stability requirements (e.g., accuracy, consistency, latency, calibration, or robustness requirements) may be removed from the dataset. In some embodiments, data (i.e., object images) for which a corresponding position or orientation data was not determined may be removed from the dataset. In some embodiments, training module 250 may modify data collection protocols to ensure edge cases (e.g., cases wherein an image of an object is captured in low-light conditions, cases wherein an image of an object includes a marginal occlusion of the object) are well-represented in a dataset.

In some embodiments, the AI model may include an input layer that may take as input preprocessed (e.g., labeled) images. In some embodiments, the AI model may include a computer vision (CV) machine learning (ML) architecture, which may be trained using deep learning algorithms. In some embodiments, the AI model may include one or more convolution layers that may extract features from the preprocessed images using one or more convolutional neural networks (CNNs) to capture essential patterns and characteristics of the object. In some embodiments, the AI model may include one or more pooling layers to reduce dimensionality while retaining important features, improving computational efficiency. In some embodiments, the features may be fully connected to an output layer, allowing the model to learn complex relationships between images of the object and position or orientation data of the object. In some embodiments, the AI model may include an output layer that may produce the predicted position of the object in a field of view of the client device. In some embodiments, the predicted position in a field of view of the client device may be represented in the same format as the position of the object in the physical space. In some embodiments, ablation analysis may be conducted on data volume to ensure an amount of data is sufficient, or ablation analysis may be conducted on data features to identify what features contribute most to the predictions of an AI model.

In some embodiments, training module 250 may divide a dataset into training sets, validation sets, or testing sets (e.g., 60 percent training, 20 percent validation, 20 percent testing). In some embodiments, training module 250 may normalize images for consistent input size or scale. In some embodiments, training module 250 may augment the dataset through techniques such as rotation, flipping, or color adjustment to improve generalization. In some embodiments, training module 250 may implement a departmentalized inference engine to handle diverse data, including data from multiple types of integrated sensors of a tracked object or data from multiple types of images of a tracked acquired by a head-mounted display (HMD). In some embodiments, training module 250 may use an appropriate loss function (e.g., mean squared error (MSE)) to quantify the difference between predicted positions or orientations and known positions or orientations. In some embodiments, training module 250 may implement an optimizer (e.g., stochastic gradient descent (SGD)) to adjust model weights during training to minimize the loss. In some embodiments, training module 250 may train the model over several epochs, monitoring the loss on the training and validation datasets to prevent overfitting. In some embodiments, after training, training module 250 may evaluate the model using the testing set to assess an accuracy or a performance of the AI model. In some aspects of the embodiments, training module 250 may use metrics such as root mean square error (RMSE) or mean absolute error (MAE) to evaluate the model. In some embodiments, once the AI model has achieved satisfactory accuracy, the AI model may be integrated into an application for real-time object tracking. In some embodiments, training module 250 may verify an AI model implemented for training and an AI model implemented for inference are the same or are substantially similar.

Rendering module 260 may be configured to produce a digital representation of an object based on tracking data (e.g., real-time tracking data) of the object. Rendering module 260 may allow the object to be visually integrated into a mixed reality (MR) environment or interactive simulation. Based on a predicted position or orientation of the object in a field of view of a client device, rendering module 260 may generate a three-dimensional model of the object. The three-dimensional model of the object may define a geometry, texture, or material property of the object.

In some embodiments, rendering module 260 may implement level of detail (LOD) techniques to optimize rendering by selecting appropriate model detail based on, for example, a distance of the object from the client device. In some embodiments, rendering module 260 may transform predicted position or orientation data into a format suitable for rendering. In some aspects of the embodiments, transforming predicted position or orientation data into a format suitable for rendering may include transforming the coordinates of the object from a global space (e.g., the physical space) to a local space (e.g., a space of the client device). In some embodiments, rendering module 260 may apply perspective or orthographic projection to simulate how the object may appear on or in a display of the client device, considering the field of view of the client device or other intrinsic parameters of the client device. In some embodiments, rendering module 260 may utilize vertex or fragment shaders to manage how the object is rendered on or in the display of the client device. In some embodiments, rendering module 260 may implement one or more lighting techniques (e.g., physically-based rendering) to enhance the realism of the digital representation, accounting for ambient, diffuse, or specular lighting based on the physical space. In some embodiments, rendering module 260 may apply textures to the three-dimensional model to provide realistic surfaces. In some embodiments, rendering module 260 may utilize depth testing or occlusion culling to ensure the digital representation interacts correctly with the real-world environment. For example, if a real-world object obstructs the view of the digital representation, then rendering module 260 may respect or prioritize the occlusion. In some embodiments, rendering module 260 may integrate effects such as shadows, reflections, or environmental lighting to enhance the immersion of the digital representation within the real world. In some embodiments, based on a performance capability of the client device, rendering module 260 may dynamically adjust a rendering quality to maintain responsiveness.

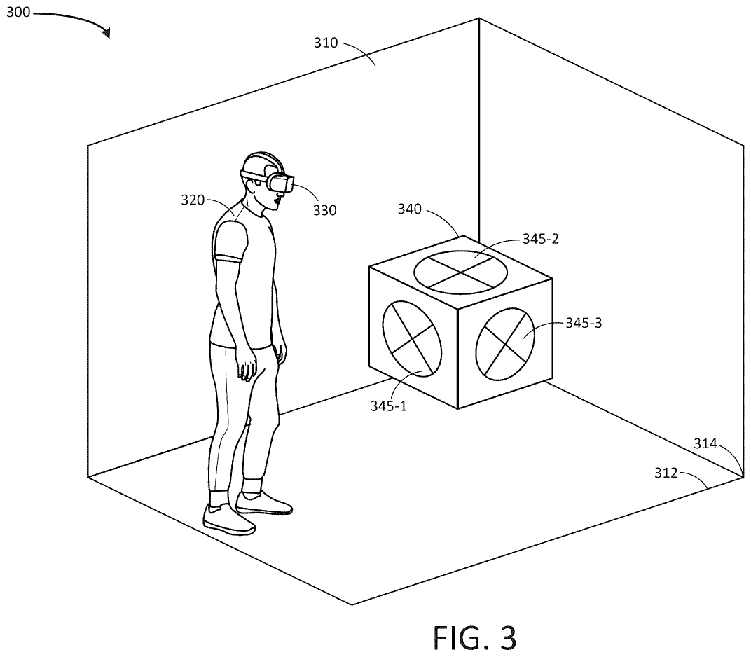

FIG. 3 illustrates an example configuration 300 for object tracking using integrated cameras 345 of an object 340, according to some embodiments. As shown in FIG. 3, physical space 310 may include edge 312; corner 314; user 320, wearing head-mounted display (HMD) 330; and integrated cameras 345, which may include integrated camera 345-1, integrated camera 345-2, and integrated camera 345-3. By way of non-limiting example, object 340 may include a handheld controller communicatively coupled to HMD 330.

In some embodiments of example configuration 300, inside-out tracking may be used to track a position or an orientation of object 340 in physical space 310 surrounding object 340. Integrated cameras 345 may be physical components of object 340. Integrated cameras 345 may be coupled to, affixed to, adhered to, embedded in, or otherwise physically connected to object 340. Artificial intelligence (AI) algorithms may be used to map physical space 310. Mapping physical space 310 may include identifying a distinct feature of physical space 310 (e.g., edge 312 or corner 314). One or more features of physical space 310 may be used as reference points to determine a position or an orientation of object 340 within physical space 310 as object 340 moves within physical space 310. By continuously detecting or analyzing the movement of object 340 relative to the reference points, a position or an orientation of object 340 may be determined in real time.

In some embodiments of example configuration 300, integrated cameras 345 may capture one or more images of physical space 310. In some aspects of the embodiments, the one or more images may include true-color (also known as natural-color) images, which may refer to images that accurately depict colors as the colors would be perceived by the human eye in natural daylight (e.g., RGB images). In some aspects of the embodiments, the image may include false-color (also known as pseudo-color) images, which may refer to images that do not depict colors as the colors would be perceived by the human eye in natural daylight (e.g., infrared (IR) images). False-color images may be created using solely the visual spectrum, or false-color images may be created at least partially from electromagnetic radiation (EM) data outside the visual spectrum (e.g., infrared, ultraviolet, or X-ray). In some embodiments of example configuration 300, object 340 may include an IMU, which may include an accelerometer or a gyroscope. IMU data and image data may be used to determine a position or an orientation of object 340 in physical space 310 or to improve an accuracy of a position or an orientation of object 340 in physical space 310.

In some embodiments of example configuration 300, an artificial intelligence (AI) model (e.g., a machine learning (ML) model) may be trained to determine a position or an orientation of object 340 within a field of view of HMD 330. A dataset for training, validating, or testing the AI model may include a plurality of images of object 340. The plurality of images may be captured by HMD 330 as HMD 330 or object 340 moves within physical space 310 surrounding HMD 330 and object 340. The plurality of images of object 340 may be captured under various conditions, including different angles, lighting, backgrounds, or distances. Each image of the plurality of images may be labeled with position or orientation data. The position or orientation data may include, respectively, a position or an orientation of object 340 within physical space 310 at the time an image was captured by HMD 330. In some embodiments, the dataset may include at least a threshold number of variations (e.g., occlusions, backgrounds, lighting conditions) to improve the robustness of the AI model.

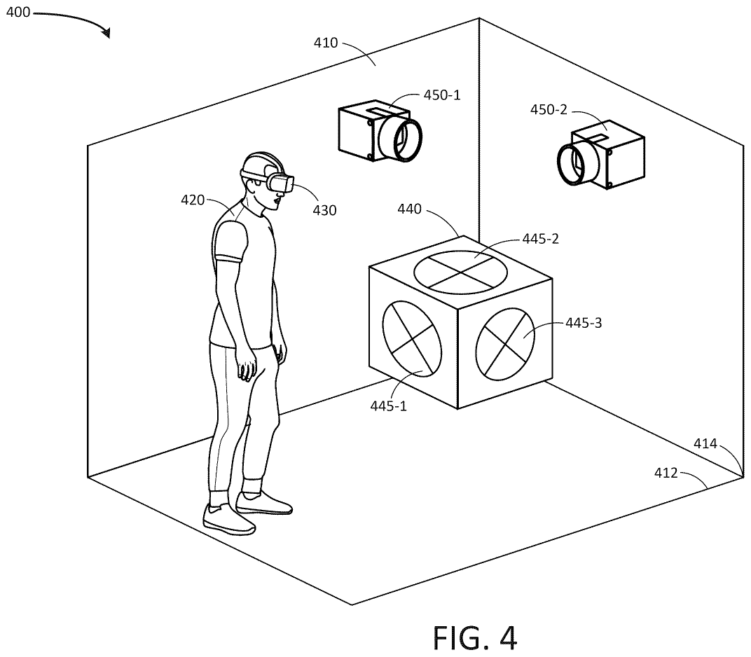

FIG. 4 illustrates an example configuration 400 for object tracking using non-integrated cameras 450 associated with object 440, according to some embodiments. As shown in FIG. 4, physical space 410 may include edge 412; corner 414; user 420, wearing head-mounted display (HMD) 430; integrated components 445, which may include integrated component 445-1, integrated component 445-2, and integrated component 445-3, and non-integrated cameras 450, which may include non-integrated camera 450-1 and non-integrated camera 450-2. By way of non-limiting example, object 440 may include a handheld controller communicatively coupled to HMD 430. By way of non-limiting example, non-integrated cameras 450 may include external motion capture cameras for tracking object 440 in physical space 410. By way of non-limiting example, integrated components 445 may include infrared (IR) light-emitting diodes (LEDs).

In some embodiments of example configuration 400, outside-in tracking may be used to track a position or an orientation of object 440 in physical space 410 surrounding object 440. Non-integrated cameras 450 may be external devices associated with object 440. Non-integrated cameras 450 may be uncoupled from, unaffixed to, unadhered to, unembedded in, or otherwise physically disconnected from object 440. Artificial intelligence (AI) algorithms may be used to map physical space 410. Mapping physical space 410 may include identifying a distinct feature of physical space 410 (e.g., edge 412 or corner 414). One or more features of physical space 410 may be used as reference points to determine a position or an orientation of object 440 within physical space 410 as object 440 moves within physical space 410. By continuously detecting or analyzing the movement of object 440 relative to the reference points, a position or an orientation of object 440 may be determined in real time.

In some embodiments of example configuration 400, object 440 may include integrated components 445. Integrated components 445 may be detected by non-integrated cameras 450 to track a position or an orientation of object 440 in physical space 410. Integrated components 445 may be physical components of object 440. Integrated components 445 may be coupled to, affixed to, adhered to, embedded in, or otherwise physically connected to object 440. Non-integrated cameras 450 may capture one or more images of object 440 or physical space 410 surrounding object 440. In some aspects of the embodiments, the one or more images may include true-color (also known as natural-color) images, which may refer to images that accurately depict colors as the colors would be perceived by the human eye in natural daylight (e.g., RGB images). In some aspects of the embodiments, the one or more images may include false-color (also known as pseudo-color) images, which may refer to images that do not depict colors as the colors would be perceived by the human eye in natural daylight (e.g., infrared (IR) images). False-color images may be created using solely the visual spectrum, or false-color images may be created at least partially from electromagnetic radiation (EM) data outside the visual spectrum (e.g., infrared, ultraviolet, or X-ray). In some embodiments, the object may include an IMU, which may include an accelerometer or a gyroscope. IMU data and image data may be used to determine a position or an orientation of object 440 in physical space 410 or to improve an accuracy of a position or an orientation of object 440 in physical space 410.

In some embodiments of example configuration 400, an artificial intelligence (AI) model (e.g., a machine learning (ML) model) may be trained to determine a position or an orientation of object 440 within a field of view of HMD 430. A dataset for training, validating, or testing the AI model may include a plurality of images of object 440. The plurality of images may be captured by HMD 430 as HMD 430 or object 440 moves within physical space 410 surrounding HMD 430 and object 440. The plurality of images of object 440 may be captured under various conditions, including different angles, lighting, backgrounds, or distances. Each image of the plurality of images may be labeled with position or orientation data. The position or orientation data may include, respectively, a position or an orientation of object 440 within physical space 410 at the time an image was captured by HMD 430. In some embodiments, the dataset may include at least a threshold number of variations (e.g., occlusions, backgrounds, lighting conditions) to improve the robustness of the AI model.

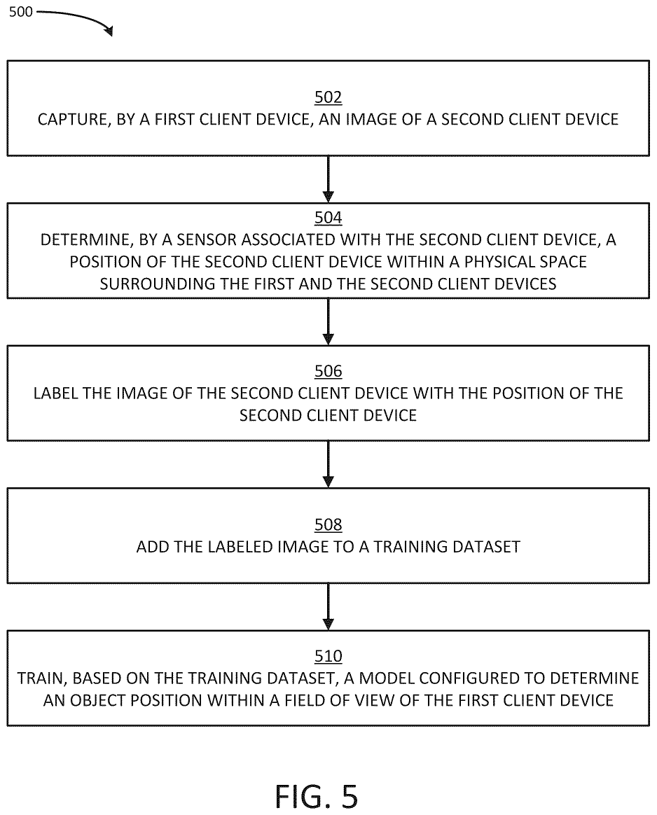

FIG. 5 is a flowchart illustrating operations in a method 500 for object tracking, according to some embodiments. In some embodiments, processes as disclosed herein may include one or more operations in method 500 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 500 may be performed by an inside-out tracking module, an outside-in tracking module, a training module, or a rendering module (e.g., inside-out tracking module 230, outside-in tracking module 240, training module 250, or rendering module 260). In some embodiments, processes consistent with the present disclosure may include at least one or more operations as in method 500 performed in a different order, simultaneously, quasi-simultaneously, or overlapping in time.

Operation 502 may include capturing, by a first client device, an image of a second client device. In some embodiments, the first client device may include a head-mounted display (HMD). In some embodiments, the second client device may include at least one handheld controller associated with the HMD. In some embodiments, the first client device may be communicatively coupled to the second client device.

Operation 504 may include determining, by a sensor associated with the second client device, a position of the second client device within a physical space surrounding the first and the second client devices. In some embodiments, the sensor may include at least one camera. In some aspects of the embodiments, the at least one camera may capture at least one of true-color images and false-color images.

In some embodiments of operation 504, the sensor associated with the second client device may be an integrated sensor of the second client device. In some aspects of the embodiments, determining the position of the second client device within the physical space surrounding the first and the second client devices may include capturing, by the sensor associated with the second client device, a plurality of images of the physical space as the second client device moves within the physical space. In some aspects of the embodiments, determining the position of the second client device within the physical space surrounding the first and the second client devices may include identifying, based on the plurality of images, at least one feature of the physical space, wherein the at least one feature includes at least one of an edge, a corner, or a texture of the physical space. In some aspects of the embodiments, determining the position of the second client device within the physical space surrounding the first and the second client devices may include determining the position of the second client device relative to the at least one feature of the physical space.

In some embodiments of operation 504, the sensor associated with the second client device may be a non-integrated sensor associated with the second client device. In some aspects of the embodiments, determining the position of the second client device within the physical space surrounding the first and the second client devices may include capturing, by the sensor associated with the second client device, a plurality of images of the second client device as the second client device moves within the physical space. In some aspects of the embodiments, determining the position of the second client device within the physical space surrounding the first and the second client devices may include identifying, based on the plurality of images, at least one feature of the physical space, wherein the at least one feature includes at least one of an edge, a corner, or a texture of the physical space. In some aspects of the embodiments, determining the position of the second client device within the physical space surrounding the first and the second client devices may include identifying, based on the plurality of images, at least one integrated component of the second client device, wherein the at least one integrated component includes at least one infrared (IR) light-emitting diode (LED) physically coupled to the second client device. In some aspects of the embodiments, determining the position of the second client device within the physical space surrounding the first and the second client devices may include determining the position of the at least one integrated component of the second client device relative to the at least one feature of the physical space.

Operation 506 may include labeling the image of the second client device with the position of the second client device. Operation 508 may include adding the image to a training dataset. In some embodiments, the training dataset may include a plurality of images of the second client device labeled with a plurality of positions of the second client device.

Operation 510 may include training, based on the training dataset, a model configured to determine an object position within a field of view of the first client device. In further aspects of the embodiments, operation 510 may include rendering, based on the model, a digital representation of the second client device in a display of the first client device, wherein the digital representation of the second client device is visually consistent with the image of the second client device.

### Hardware Overview

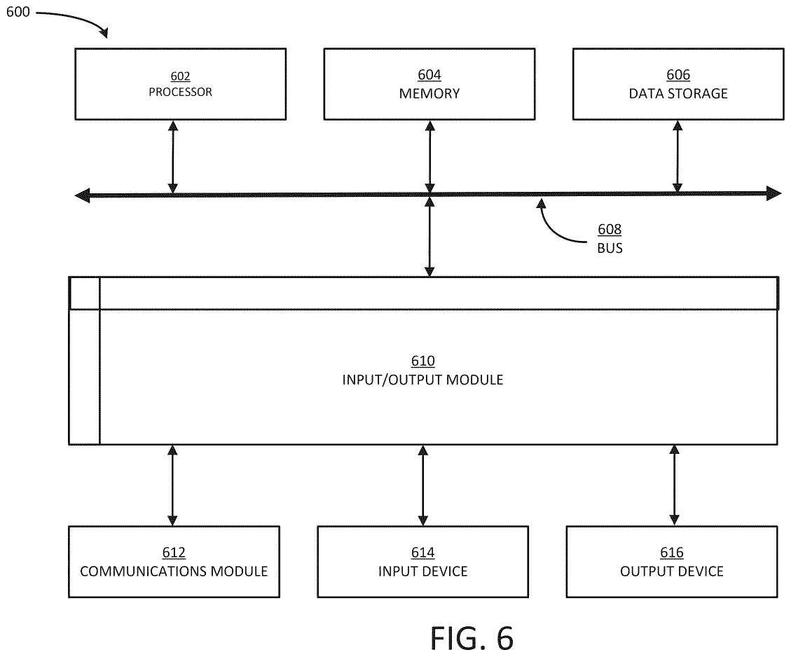

FIG. 6 is a block diagram illustrating an exemplary computer system 600 with which client devices, and the methods in FIG. 5, may be implemented, according to some embodiments. In certain aspects, computer system 600 may be implemented using hardware or a combination of software and hardware, either in a dedicated server, or integrated into another entity, or distributed across multiple entities.

Computer system 600 (e.g., client device(s) 110 and server(s) 130) may include bus 608 or another communication mechanism for communicating information, and a processor 602 (e.g., processors 212) coupled with bus 608 for processing information. By way of example, computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 600 may include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. Processor 602 and memory 604 may be supplemented by, or incorporated in, special purpose logic circuitry.

The instructions may be stored in memory 604 and implemented in one or more computer program products, e.g., one or more modules of computer program instructions encoded on a computer-readable medium for execution by, or to control the operation of, computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 may be any input/output module. Exemplary input/output modules 610 include data ports such as Universal Serial Bus (USB) ports. The input/output module 610 may be configured to connect to a communications module 612. Exemplary communications modules 612 (e.g., communications modules 218) include networking interface cards, such as Ethernet cards and modems. In certain aspects, input/output module 610 may be configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a user may provide input to computer system 600. Other kinds of input devices 614 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 616 include display devices, such as an LCD (liquid crystal display) monitor, for displaying information to the user.

According to one aspect of the present disclosure, client device(s) 110 and server(s) 130 may be implemented using computer system 600 in response to processor 602 executing one or more sequences of one or more instructions contained in memory 604. Such instructions may be read into memory 604 from another machine-readable medium, such as data storage device 606. Execution of the sequences of instructions contained in memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 600 may include clients and servers. A client and server may be generally remote from each other and typically interact through a communication network. The relationship of client and server arises by virtue of computer programs running on the respective computers and having a client-server relationship to each other. Computer system 600 may be, for example, and without limitation, a desktop computer, laptop computer, or tablet computer. Computer system 600 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method for object tracking, comprising:
capturing, by a first client device, an image of a second client device;
determining, by a sensor associated with the second client device, a position of the second client device within a physical space surrounding the first and the second client devices;
labeling the image of the second client device with the position of the second client device;
adding the image to a training dataset; and
training, based on the training dataset, a model configured to determine an object position within a field of view of the first client device.

2. The computer-implemented method of claim 1, wherein:
the first client device includes a head-mounted display (HMD); and
the second client device includes at least one handheld controller associated with the HMD.

3. The computer-implemented method of claim 1, wherein the first client device is communicatively coupled to the second client device.

4. The computer-implemented method of claim 1, wherein:
the sensor includes at least one camera; and
the at least one camera captures at least one of true-color images and false-color images.

5. The computer-implemented method of claim 1, wherein the sensor associated with the second client device is an integrated sensor of the second client device.

6. The computer-implemented method of claim 5, wherein determining the position of the second client device within the physical space surrounding the first and the second client devices includes:
capturing, by the sensor associated with the second client device, a plurality of images of the physical space as the second client device moves within the physical space;
identifying, based on the plurality of images, at least one feature of the physical space, wherein the at least one feature includes at least one of an edge, a corner, or a texture of the physical space; and
determining the position of the second client device relative to the at least one feature of the physical space.

7. The computer-implemented method of claim 1, wherein the sensor associated with the second client device is a non-integrated sensor associated with the second client device.

8. The computer-implemented method of claim 7, wherein determining the position of the second client device within the physical space surrounding the first and the second client devices includes:
capturing, by the sensor associated with the second client device, a plurality of images of the second client device as the second client device moves within the physical space;
identifying, based on the plurality of images, at least one feature of the physical space, wherein the at least one feature includes at least one of an edge, a corner, or a texture of the physical space;
identifying, based on the plurality of images, at least one integrated component of the second client device, wherein the at least one integrated component includes at least one infrared (IR) light-emitting diode (LED) physically coupled to the second client device; and
determining the position of the at least one integrated component of the second client device relative to the at least one feature of the physical space.

9. The computer-implemented method of claim 1, wherein the training dataset includes a plurality of images of the second client device labeled with a plurality of positions of the second client device.

10. The computer-implemented method of claim 1, further comprising rendering, based on the model, a digital representation of the second client device in a display of the first client device, wherein the digital representation of the second client device is visually consistent with the image of the second client device.

11. A system, comprising:
one or more processors; and
a memory storing instructions that, when executed by the one or more processors, cause the system to perform operations including:
capturing, by a first client device, an image of a second client device;
determining, by a sensor associated with the second client device, a position of the second client device within a physical space surrounding the first and the second client devices;
labeling the image of the second client device with the position of the second client device;
adding the image to a training dataset; and
training, based on the training dataset, a model configured to determine an object position within a field of view of the first client device.

12. The system of claim 11, wherein:
the first client device includes a head-mounted display (HMD);
the second client device includes at least one handheld controller associated with the HMD; and
the first client device is communicatively coupled to the second client device.

13. The system of claim 11, wherein:
the sensor includes at least one camera; and
the at least one camera captures at least one of true-color images and false-color images.

14. The system of claim 11, wherein the sensor associated with the second client device is an integrated sensor of the second client device.

15. The system of claim 14, wherein determining the position of the second client device within the physical space surrounding the first and the second client devices includes:
capturing, by the sensor associated with the second client device, a plurality of images of the physical space as the second client device moves within the physical space;
identifying, based on the plurality of images, at least one feature of the physical space, wherein the at least one feature includes at least one of an edge, a corner, or a texture of the physical space; and
determining the position of the second client device relative to the at least one feature of the physical space.

16. The system of claim 11, wherein the sensor associated with the second client device is a non-integrated sensor associated with the second client device.

17. The system of claim 16, wherein determining the position of the second client device within the physical space surrounding the first and the second client devices includes:
capturing, by the sensor associated with the second client device, a plurality of images of the second client device as the second client device moves within the physical space;
identifying, based on the plurality of images, at least one feature of the physical space, wherein the at least one feature includes at least one of an edge, a corner, or a texture of the physical space;
identifying, based on the plurality of images, at least one integrated component of the second client device, wherein the at least one integrated component includes at least one infrared (IR) light-emitting diode (LED) physically coupled to the second client device; and
determining the position of the at least one integrated component of the second client device relative to the at least one feature of the physical space.

18. The system of claim 11, wherein the training dataset includes a plurality of images of the second client device labeled with a plurality of positions of the second client device.

19. The system of claim 11, wherein the operations further comprise rendering, based on the model, a digital representation of the second client device in a display of the first client device, wherein the digital representation of the second client device is visually consistent with the image of the second client device.

20. A non-transitory computer-readable storage medium storing instructions encoded thereon that, when executed by a processor, cause the processor to perform operations comprising:
capturing, by a first client device, an image of a second client device, wherein the first client device includes a head-mounted display (HMD), and wherein the second client device includes at least one handheld controller communicatively coupled with the HMD;
determining, by a sensor associated with the second client device, a position of the second client device within a physical space surrounding the first and the second client devices, wherein the sensor associated with the second client device is an integrated sensor of the second client device;
labeling the image of the second client device with the position of the second client device;
adding the image to a training dataset including a plurality of images of the second client device labeled with a plurality of positions of the second client device;
training, based on the training dataset, a model configured to determine an object position within a field of view of the first client device; and
rendering, based on the model, a digital representation of the second client device in a display of the first client device, wherein the digital representation of the second client device is visually consistent with the image of the second client device.
